(19) United States
(12) Patent Application Publication
(10) Pub. No.: US 2016/0381414 A1
(43) Pub. Date: Dec. 29, 2016

(54) POWER SAVING AUDIO-VIDEO PLAYBACK

(71) Applicant: ATI Technologies ULC, Markham (CA)

(72) Inventors: Christopher Legair-Bradley, Markham (CA); Oleksandr Khodorkovsky, Toronto (CA)

(73) Assignee: ATI TECHNOLOGIES ULC, Markham (CA)

(21) Appl. No.: 14/749,225

(22) Filed: Jun. 24, 2015

(51) Int. Cl. H04N 21/443; H04N 21/439; H04N 21/434; H04N 21/426; H04N 21/437; H04N 21/454; H04N 21/6379; H04N 21/6437; H04N 21/44; H04N 21/438

(52) U.S. Cl. CPC H04N 21/4436; H04N 21/44; H04N 21/4396; H04N 21/4341; H04N 21/4382; H04N 21/437; H04N 21/4542; H04N 21/6379; H04N 21/6437; H04N 21/42615

(57) ABSTRACT

A communications device, a communications system, a method, and a computer readable storage device having a non-transitory computer program stored thereon, are disclosed. All of these are directed to reducing power consumption associated with processing of audio-video (AV) content, such as streaming video.

### TECHNICAL FIELD

The disclosed embodiments are directed to audio-video processing methods and devices.

### BACKGROUND

Audio-video (AV) content refers to, for example, moving images with sound. Streaming media, an example of AV content, is received by an end user from a provider and presented while being delivered. Streaming refers to the process of delivering media, i.e., the delivery method of the medium, and not the medium itself. Typically, data begins to be processed at a receiver and presented to the user before an entire file containing the data has been transmitted. AV transmissions have both video and audio components, with the video often, but not necessarily, requiring more bandwidth and power usage than the audio.

In recent years, the Internet and Internet providers have expanded their capabilities for greater bandwidth, increased access, and reliability. With this has come the growth of the streaming video industry. The streaming data supplied to a client/user/subscriber is currently supplied from several sources, such as stored files provided by the market from a catalog of audio-video performances, live streams of whole concerts, sporting events, live political speeches, and personally stored files in elected data storage either locally, or in a distant server, sometimes referred to as a cloud. Additionally, there have been significant advances in mobile technology such as cell phones and tablet computers. Smart phones and smart tablets are able to access wireless networks, such as the Internet, for live video or stored video presentations.

With this expansion in technology has come the growth of streaming video providers such as YouTube®, Netflix®, Jazz.org®, IMVDb®, and iTunes®. These providers offer downloadable application software for viewing their offerings. Providers also offer multimedia applications. The applications can vary in the protocols used with real-time streaming protocol (RTSP) being representative.

### SUMMARY OF THE EMBODIMENTS

A communications device, a communications system, a method, and a computer readable storage device having a non-transitory computer program stored thereon, are all directed to reducing power consumption associated with processing of audio-video (AV) content, such as streaming video. The communications device includes a processor configured to receive an encoded AV signal; splitting circuitry configured to receive the encoded AV signal from the processor and to split the AV signal into an encoded audio signal and an encoded video signal; video processing circuitry configured to receive the encoded video signal, process the encoded video signal, and send a resulting processed encoded video signal to be displayed on a video display; audio processing circuitry configured to receive the encoded audio signal, process the encoded audio signal, and provide decoded audio to a speaker; and a video pass-block module configured to receive a pass-block instruction from the processor and, according to the instruction, either pass the encoded video signal to the video processing circuitry or block the encoded video signal from reaching the video processing circuitry.

The communications system includes a provider of AV content and an associated transmitter of the AV content, and a communications device configured to receive and present the AV content. The communications device is further configured to transmit a request to the provider to provide a requested encoded signal that is either an encoded audio signal only or an encoded video signal only, the encoded audio signal representing audio content of the AV content and the encoded video signal representing video content of the AV content; receive the requested encoded signal; and decode and process the received requested signal and present the decoded and processed signal to a user.

The method, in one embodiment, includes splitting a received AV signal into an encoded audio signal and an encoded video signal; and blocking either the encoded video signal or the encoded audio signal from being processed and decoded. In another embodiment, the method includes transmitting a request to a provider of the AV content to provide a requested AV signal that is either an encoded audio signal only or an encoded video signal only, the encoded audio signal representing audio content of the AV content and the encoded video signal representing video content of the AV content; receiving the requested encoded signal; and decoding and processing the received requested signal and presenting the decoded and processed signal to a user.

A non-transitory computer program stored on the computer readable storage device, when executed by a computing device, may cause the computing device to execute one or the other or both embodiments of the method.

### BRIEF DESCRIPTION OF THE DRAWINGS

A more detailed understanding may be had from the following description, given by way of example in conjunction with the accompanying drawings wherein:

FIG. 1 shows a block diagram of an AV communication system;

FIG. 2 shows an embodiment of an AV communications device and an associated system;

FIG. 3 shows another embodiment of an AV communications device and an associated system;

FIG. 4 shows an embodiment of a method for power reduction in an AV communications system; and

FIG. 5 shows another embodiment of a method for power reduction in an AV communications system.

### DETAILED DESCRIPTION OF THE EMBODIMENTS

A user may be interested in only an audio portion or only a video portion of an audio-video (AV) content object such as a streaming video. For example, a user may want to listen only to the audio portion of a received presentation format, because he or she is otherwise occupied and cannot view the video, or because they are at work, or in public, or exercising, or operating machinery, or driving. As an example, the user may want to listen to a movie score or a television program audio without viewing the movie or TV show. If only a portion of AV content is desired by a user, there may be no need to process and render remaining undesired portions of the content. If such processing and rendering is omitted, significant reduction in power and bandwidth requirements may be obtained in receiving devices and in content transmission systems. Power reduction is particularly desirable in battery-powered receiving devices such as mobile devices.

Disclosed herein are a communications device and system configured to receiving and play AV content, such as a streaming video program, with reduced power requirements. The circuitry modification and augmentation can be implemented with hardware (HW) or software (SW), or a combination of both. Also disclosed are methods of selectively playing audio only or video only to reduce power use in the communications device.

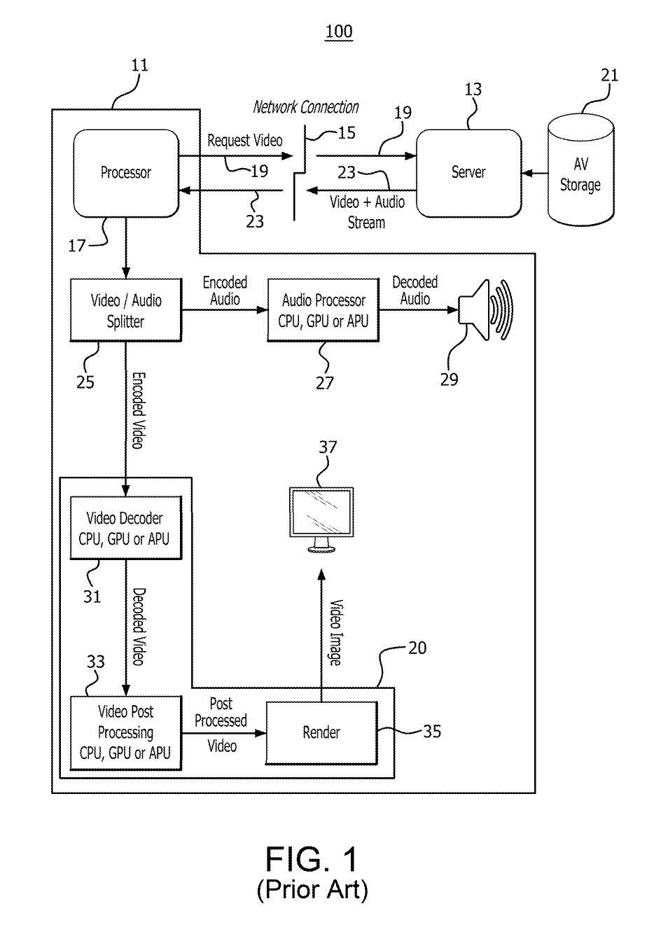

An overview of an existing system 100 for delivery of AV content is shown in FIG. 1. A communications device 11 is configured to receive AV content, process the AV content, and present AV content to a user (not shown). Communications device 11 may be a mobile device but is not necessarily limited to being mobile. Communications device 11 may be, but is not limited to, a smart phone, a tablet, a laptop computer, a desktop computer, or other devices. Communications device 11 includes a processor 17 that may be, but is not limited to, a central processing unit (CPU), graphics processing unit (GPU), accelerated processing unit (APU) or any other processor suitable for processing of AV content. Processor 17, perhaps acting as a client in a client-server relationship, communicates with a server 13 of an AV content provider via a network connection 15, such as the Internet or a wireless cellular communication network. Processor 17 may send a request 19 for specific AV content, such as a streaming video program, to server 13. Server 13 may retrieve requested AV content from database storage 21. The requested AV content is sent via network connection 15 to processor 17 as an encoded AV signal 23. Processor 17 feeds encoded AV signal 23, perhaps after some preliminary processing, to a video/audio splitter 25. Splitter 25 splits the encoded AV signal into an encoded audio signal and an encoded video signal. The encoded audio signal is sent from the splitter 25 to an audio processor 27, such as, but not limited to, a CPU, GPU, APU, or similar. Audio processor processes and decodes the encoded audio signal and drives a speaker 29 with the decoded audio signal.

At the same time, splitter 25 sends encoded video to a video processing circuitry 20 that processes and decodes the encoded video signal and drives a video display 37 with the decoded video signal. Video processing circuitry 20 may include, but is not limited to include, at least one of a video decoder module 31, a video post-processing module 33, or a video rendering module 35. Video decoder module 31 may receive the encoded video signal from splitter 25, produce therefrom a decoded video signal and feed the decoded video signal to a video post-processing module 33. Video post-processing module 33 may produce from the decoded video signal a post-processed video signal which is then received by a video rendering module 35. Video rendering module 35 produces, from the post-processed video signal, a video image signal that is received by and displayed by video display 37. Audio and video processing are conducted simultaneously and synchronized so that the viewer sees and hears the AV content properly.

Processing of encoded video requires relatively large amounts of power that can quickly drain a battery in an AV device. This can limit the length of time an AV content item, such as a streaming video program, can be viewed. Video processing may also consume power that may be needed in the AV device for other functions, and may require the device to be taken out of service for recharging of the battery. With some AV content, a user may be interested only in, for example, an audio portion and not interested in a video portion. As one example, a user may want to listen to a song in a music video but not actually watch the video.

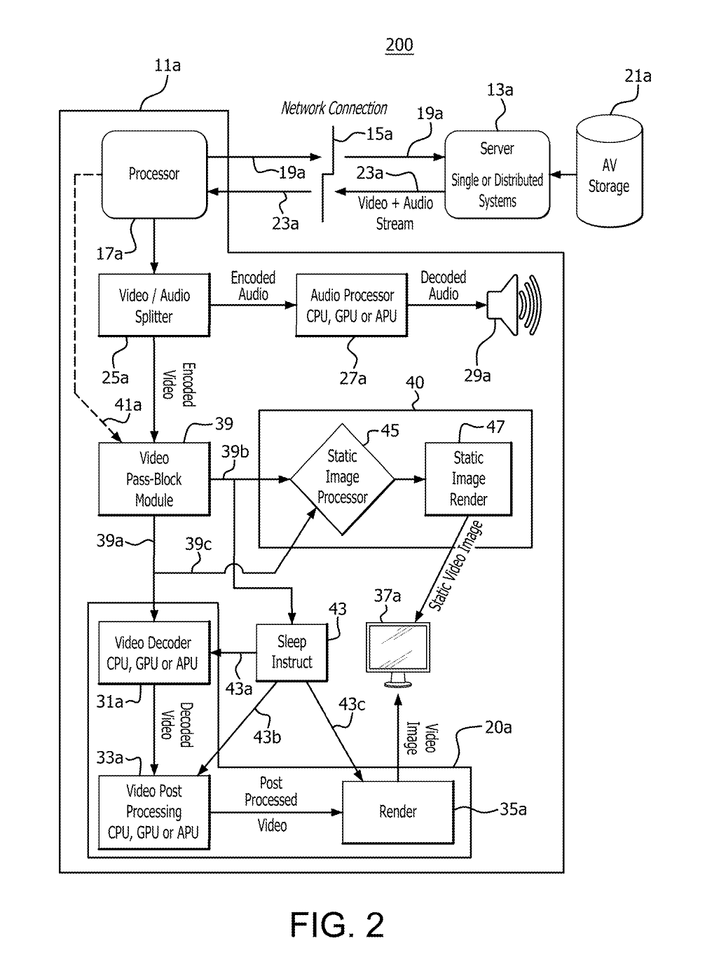

FIG. 2, then, shows an embodiment of a system 200 configured to reduce power consumption in AV transmission, reception, and processing. Power reduction may be achieved in this embodiment by enabling turning off all or nearly all of the video processing and presenting only the audio portion of an AV program to a user. In general, processing and displaying of video information requires significantly more power than processing audio information accompanying video information for at least two reasons: with audio only, there is less information needing processing and an audio transducer, such as a speaker, consumes less power than a continuously illuminated video display. Eliminating at least a majority of video processing and displaying will reduce power consumption and lengthen battery life in an AV device.

Returning to FIG. 2, inserted between video/audio splitter 25a and video processing circuitry 20a is a video pass-block module, or filter, 39. Video pass-block module 39 is configured to receive a user-initiated instruction 41a from processor 17a to either permit the encoded video signal from video/audio splitter 25a to pass through to video processing circuitry 20a and video display 37, or to be blocked from passing through. When video is permitted to pass, video processing circuitry 20a and video display 37a operate as previously described, with video processing circuitry 20a receiving encoded video signal from a first output 39a of video pass-block module 39. On the other hand, when video pass-block module 39 receives instruction 41a to block video, powering of video processing circuitry 20a is not needed. In that case, video processing circuitry 20a may be powered down to reduce power consumption, as described in the following embodiments.

Many devices, including those powered by batteries, contain circuitry that powers down (goes to sleep) if presented with no signals for processing for a predetermined period of time. On the other hand, some mobile devices do not contain such circuitry. Even where video processing circuitry 20a includes a sleep function, it may be desirable to accelerate operation of the sleep function. If video processing circuitry 20a goes into a sleep mode automatically after some minutes, it may be that nothing further needs to be done to reduce power consumption. Alternatively, video processing circuitry 20a may be put into a sleep mode upon receiving a sleep instruction from a sleep instruction generator module 43. In an embodiment shown in FIG. 2, not to be considered limiting, sleep instruction generator module 43 responds to an output connection 39b from video pass-block module 39 indicating that the latter is blocking the encoded video signal. In response, sleep instruction generator module 43 may send signals to each of at least one component of video processing circuitry 20a, instructing those components to turn off or go into a very low-power-consuming standby state, or sleep state. In the particular embodiment shown in FIG. 2, not to be considered limiting, three such components are shown as video decoder 31a, video post-processing module 33a, and rendering module 35a. Video display 37 may also be turned off or put in a very low power consuming standby mode. Signals to put video decoder module 31, video post-processing module 33, and video rendering module 35 into a sleep state are shown as 43a, 43b, and 43c, respectively.

In an embodiment, the system of FIG. 2 may further include static display circuitry 40 configured to generate a static image to be displayed on video display 37a when video pass-block module 39 is instructed to block the encoded video signal from reaching video processing circuitry 20a. The static image may be at least one of, but is not limited to, a received static logo, a received short message, or at least one received static video frame. The at least one received static video frame may be extracted from the otherwise blocked encoded video signal.

In an embodiment, not to be considered limiting, static display circuitry 40 includes static image processor 45 and static image render module 47. Static image processor 45, which may include logic circuitry, may receive information from at least one of output connections 39b and 39c of video pass-block module 39, or instruction 41a, (the latter connection to 41a not shown) the information including whether or not a static image is to be presented.

Static display circuitry 40 may be configured to receive static video data from video pass-block module 39 over connection 39a-39c and feed this data to a static image render module 47. Static image render module 47 renders the static video image data and feeds a static image signal to video display 37a. The static image may be temporarily displayed as a signal to the user that the video block is operating properly and audio only will be playing. Alternatively, the static image may be displayed for the duration of the AV program. Static image processor 45 may also receive instructions from video pass-block module 39 to refresh or change a static image from time to time.

If no static video images are to be displayed, static display circuitry 40 may receive an instruction to power down, thus providing additional power reduction. This instruction to power down may be received by static display circuitry 40 over at least one of connections 39b or 39c. This instruction to power down may be received by static display circuitry 40 directly from video/audio splitter 25a or directly from processor 17a or from instruction 41a; these paths are not shown in FIG. 2. This instruction may be received by static display circuitry 40 from sleep instruction generator module 43, this connection not shown in FIG. 2.

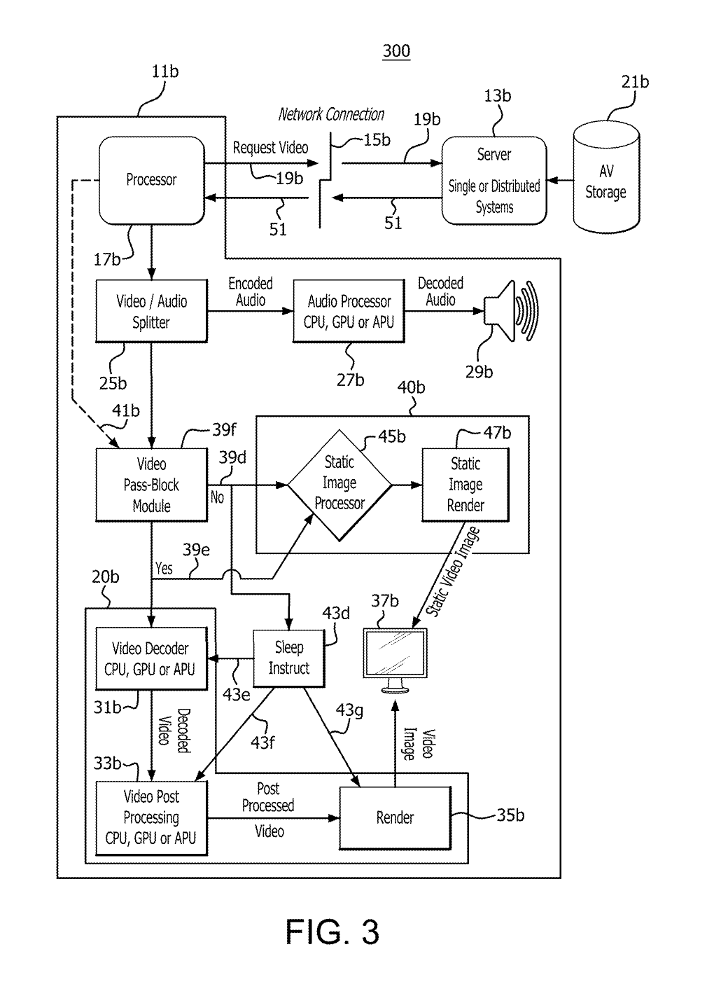

FIG. 3 shows an alternative embodiment 300 of a system configured to reduce power consumption in AV transmission, reception, and processing by eliminating video or audio processing. In this embodiment, video information in an AV content object is removed on a server side of a network connection instead of a client side as described previously. In the embodiment of FIG. 3 a user of communications device 11b, which may be a mobile communications device but is not limited thereto, may cause communications device 11b to send a request 19b to receive, for example, only an audio portion of an AV content object. Request 19b may be transmitted from processor 17b of communications device 11b. Request 19b may be transmitted over a network connection 15b to server 13b.

In response to such an audio only request, server 13b may obtain AV content from AV storage 21b, strip the audio information out of the AV content, encode the audio information as an encoded audio signal 51, and transmit encoded audio signal 51 to communications device 11b via network connection 15b.

Once encoded audio signal 51 is received at communications device 11b it may be processed by processor 17b, in a manner corresponding to that in the embodiment of FIG. 2. In the embodiment of FIG. 3, when only an audio signal is requested and received at communications device 11b, powering down of video processing circuitry 20b may proceed in a manner similar to that in the embodiment of FIG. 2. In the embodiment of FIG. 3, video pass-block module 39f may sense whether or not an encoded video signal is being received. Video pass-block module 39f may sense the presence or absence of a video signal by analyzing a signal from video/audio splitter 25b. Alternatively, video pass-block module 39f may sense the presence or absence of a video signal by receiving instruction 41b from processor 17b. Video pass-block module 39f may then cause instructions to be transmitted to one or more components of video processing circuitry 20b to power down or go into a low-power-consuming state, or sleep state, if no video signal has been requested. These instructions may be implemented via a sleep instruction generator module 43d similar to sleep instruction generator module 43 in FIG. 2, but other implementations are possible.

The embodiment of FIG. 3 may also include static display circuitry 40b configured to generate a static image to be displayed on video display 37b when video pass-block module 39f senses only audio (and perhaps also static image information). The static image may be at least one of, but is not limited to, a received static logo, a received short message, or at least one received static video frame. The at least one received static video frame may be requested and transmitted from AV storage 21b and server 13b.

In an embodiment, not to be considered limiting, static display circuitry 40b includes static image processor 45b and static image render module 47b. Static image processor 45b, which may include logic circuitry, may receive information from at least one of output connections 39d and 39e of video pass-block module 39f, or instruction 41b, the information including whether or not a static image is to be presented.

Static display circuitry 40b may be configured to receive static video data over any of connections 39d or 39e, or directly from video/audio splitter 25b or directly from processor 17b, or over connection 41b, the latter three connections not being shown. Static video data may be fed to static image render module 47b. Static image render module 47b renders the static video image data and feeds a static-image signal to video display 37b. The static image may be temporarily displayed as confirmation to the user that audio only will be playing. Alternatively, the static image may be displayed for the duration of the AV program. Static image processor 45b may also receive instructions via connections 39d or 39e, or directly from video/audio splitter 25b or directly from processor 17b or in instruction 41b to refresh or change a static image from time to time.

If no static video images are to be displayed, static display circuitry 40b may receive an instruction to power down, thus providing additional power reduction. This instruction to power down may be received by static display circuitry 40b over at least one of connections 39d or 39e. This instruction to power down may be received by static display circuitry 40b directly from video/audio splitter 25b or directly from processor 17b or in instruction 41b; these paths are not shown in FIG. 3. This instruction may be received by static display circuitry 40b from sleep instruction generator module 43d, this connection not shown in FIG. 3.

As explained previously, in the embodiment of FIG. 3 and in a particular example, only audio information without video information may be transmitted from server 13b to communications device (client) 11b. Therefore, a user of communications device 11b who pays based on an amount of information received (e.g. a user with a “data plan”) may realize an information cost reduction as well as a power reduction.

It is to be understood that regardless of which embodiment is being discussed, whether that of FIG. 2, FIG. 3, or any similar embodiment, an embodiment may be modified to allow a user to obtain only a video portion of an AV content item and not obtain an audio portion. In this case, power consumption may be reduced by at least partially shutting down audio processing circuitry.

It is to be understood that regardless of which embodiment is being discussed, whether that of FIG. 2, FIG. 3, or any similar embodiment, an embodiment may be modified to allow a user to obtain and render an audio portion from a first AV content object, and, simultaneously, a video portion from a second AV content object. In this case, it is to be understood that regardless of which embodiment is being discussed, whether that of FIG. 2, FIG. 3, or any similar embodiment, a request to the provider (i.e., the provider's server) identifies the program being requested. The audio only stream and the video only stream can each contain program identifier information automatically included, or included only if requested.

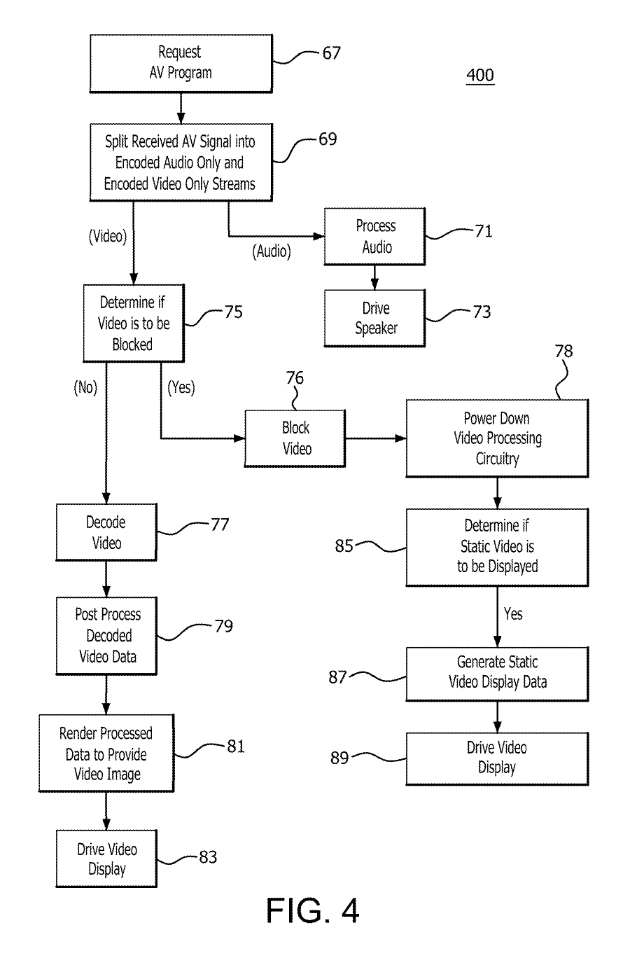

FIG. 4 shows an embodiment 400 of a method of reducing power consumption in a communications device receiving an audio-video (AV) signal or in a communication system that includes such a mobile device. An example of an AV signal is a streaming video signal. The method may be implemented in either hardware or software. Using a communication device, a user sends a request for AV content to a provider of AV content 67. The provider responds to the request and the communication device receives the requested AV content therefrom. The device then splits the AV content into two separate streams, one being an encoded audio signal only and the other an encoded video signal only 69. The encoded audio is processed 71 to drive a speaker 73. The separated encoded audio signal and encoded video signal may represent, respectively, an audio component and a video component of a single AV content object, such as a music video or other streaming video.

It is then determined whether either the encoded video signal or the encoded audio signal is to be at least partially blocked or suppressed 75 or, rather, processed, decoded, and passed for further processing and rendering to be perceived by the user. All of these determinations depend on the user's instructions to the device. In FIG. 4, an embodiment is shown in which the encoded video signal may be blocked. This is not to be considered limiting, however, and in an alternate embodiment it may be the encoded audio signal is blocked and the encoded video signal is not blocked. If the encoded video is to be blocked, the method proceeds from 75 along the “Yes” branch. Blocking of the encoded video signal is performed 76, and may be achieved by blocking that signal from reaching video processing circuitry in the device. If the video is not to be blocked, it is processed, including decoding 77, post-processing 79, and then rendering 81, to drive a video display 83.

In an embodiment, blocking of the encoded video signal 76 may be accompanied by a powering down of video processing circuitry in the device, in order to reduce power consumption 78.

Blocking of the encoded video signal may be accompanied by providing a static video display, such as a received static logo, a received short message, or at least one received static video frame. The at least one static video frame may be obtained from the encoded video signal of the AV content obtained. If it is determined 75, based on user's instructions, that the video part of the AV content is to be blocked 76, it is then determined whether or not a static video display is to be presented 85, based on the user's choice of device settings. If a static display is to be presented, a static display signal is generated 87 and provided to drive the video display 89.

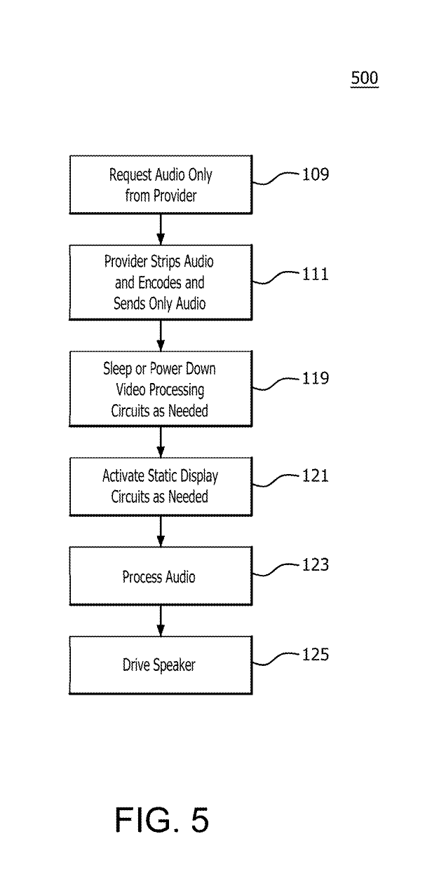

An alternative embodiment 500 of a method of reducing power consumption in a communications device or in a communications system is shown in FIG. 5. In this embodiment a user, using a communications device, may transmit a request to a provider of AV content to provide such content 109. The request may be for either an encoded audio signal only, or for an encoded video signal only. In the example shown in FIG. 5 only encoded audio is requested and provided, but this is not to be regarded as limiting. The requested audio signal and video signal may belong to a single AV content object, such as a music video or any type of streaming video object, or they may belong to different AV content objects. The requested encoded signal, audio or video, is received from the provider, decoded, processed, and presented to the user. In this embodiment 500, then, the separation of audio and video content is carried out at the provider, or server, rather than at the receiving device, or client.

If a client or user requests only streaming audio from the server or provider, the provider may select the program from a database and then strip the audio, encode the audio, and send only the audio to the client or user 111. If the requested transmission is audio only, then video processing circuitry may be powered down or put into a low-power-consuming sleep state 119 to reduce power consumption, in a manner similar to those described hereinbefore. If a static video display is desired, then static video display circuitry may be activated 121 and a static video image may be displayed, in a manner similar to those described hereinbefore. The desired encoded audio may be processed and decoded 123, and used to drive a speaker 125.

It should be understood that many variations are possible based on the disclosure herein. Although features and elements are described above in particular combinations, each feature or element may be used alone without the other features and elements or in various combinations with or without other features and elements.

The methods provided may be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors may be manufactured by configuring a manufacturing process using the results of processed hardware description language (HDL) instructions and other intermediary data including netlists (such instructions capable of being stored on a computer readable media). The results of such processing may be maskworks that are then used in a semiconductor manufacturing process to manufacture a processor which implements aspects of the embodiments.

The methods or flow charts provided herein may be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

1. A communications device configured to reduce power consumption associated with processing of audio-video (AV) content, the device comprising:
a processor configured to receive an encoded AV signal;
splitting circuitry configured to receive the encoded AV signal from the processor and to split the AV signal into an encoded audio signal and an encoded video signal;
video processing circuitry configured to receive the encoded video signal, process the encoded video signal, and send a resulting processed encoded video signal to be displayed on a video display;
audio processing circuitry configured to receive the encoded audio signal, process the encoded audio signal, and provide decoded audio to a speaker;
a video pass-block module configured to receive a pass-block instruction from the processor and, responsive to the instruction, block the encoded video signal from reaching the video processing circuitry, wherein the instruction indicates that only audio content of the AV signal is desired; and
a sleep instruction generator configured to reduce power consumption by the video processing circuitry responsive to the video pass-block module receiving the instruction that indicates that only video content of the AV signal is desired.

2. The communications device of claim 1, further comprising static display circuitry configured to generate a static image to be displayed on the video display when the pass-block module is instructed to block the encoded video signal from reaching the video processing circuitry.

3. The communications device of claim 2, wherein the static image comprises at least one of: a received static logo, a received short message, or at least one received static video frame.

4. The communications device of claim 2, further configured to power down the static display circuitry or reduce power consumption by the static display circuitry when the pass-block module is instructed to pass the encoded video to the video processing circuitry.

5. (canceled)

6. The communications device of claim 1, wherein the video processing circuitry further comprises:
a video decoder configured to receive the encoded video signal and produce therefrom a decoded video signal;
a video post-processing module configured to receive the decoded video signal and produce therefrom a post-processed video signal; and
a rendering module configured to receive the post-processed video signal and produce therefrom a video image signal that is received by, and displayed on, the video display.

7. A system configured to reduce power consumption in audio-video (AV) transmission, reception, and processing, the system comprising:
a provider of AV content and an associated transmitter of the AV content; and
a communications device configured to receive and present the AV content;
wherein the communications device is further configured to:
transmit a request to the provider to provide a requested encoded signal that comprises an encoded audio signal only, the encoded audio signal representing audio content of the AV content;
receive the requested encoded signal;
decode and process the received requested signal and present the decoded and processed signal to a user, and
wherein the communications device further comprises video processing circuitry that is configured to be put into a low-power-consuming state when the requested encoded signal is an audio signal only.

8. (canceled)

9. The system of claim 7, wherein the communications device is further configured such that when the requested encoded signal is an audio signal only, the communications device presents a static image to the user.

10. The system of claim 9, wherein the static image comprises at least one of: a received static logo, a received short message, or at least one received static video frame.

11. A method of reducing power consumption in a communications device, the method comprising:
splitting a received audio-video (AV) signal into an encoded audio signal and an encoded video signal;
processing the encoded video signal, by video processing circuitry, to generate a resulting processed encoded video signal;
responsive to receiving a pass-block instruction that indicates that only audio content of the AV signal is desired, blocking the encoded video signal from being processed by blocking the encoded video signal from being processed by the video processing circuitry; and
reducing power consumption by the video processing circuitry responsive to receiving the pass-block instruction that indicates that only video content of the AV signal is desired.

12. The method of claim 11, wherein the AV signal is a streaming video signal.

13. (canceled)

14. The method of claim 11, wherein the blocking of the encoded video signal is accompanied by displaying of a static image.

15. The method of claim 14, wherein the static image comprises at least one of: a static logo, a short message, or at least one static video frame captured from the encoded video signal.

16. The method of claim 11, wherein the encoded video signal and the encoded audio signal represent, respectively, an audio component and a video component of a single AV content object.

17. A method of reducing power consumption in a communications device, the device configured to receive and present audio-video (AV) content, the method comprising:
transmitting a request to a provider of the AV content to provide a requested encoded signal that comprises an encoded audio signal only, the encoded audio signal representing audio content of the AV content;
receiving the requested encoded signal;
decoding and processing the received requested signal and presenting the decoded and processed signal to a user; and
placing video processing circuitry of the communications device into a low-power-consuming state when the requested encoded signal is an audio signal only.

18. The method of claim 17, wherein both the audio content and the video content belong to a single AV content object.

19. The method of claim 18, wherein the single AV content object is a streaming video object.

20. (canceled)

21. The method of claim 17, further comprising displaying a static image when the requested encoded signal is an audio signal only.

22. The method of claim 21, wherein the static image comprises at least one of: a received static logo, a received short message, or at least one received static video frame.

23. A computer readable storage device having a non-transitory computer program stored thereon, execution of which by a computing device causes the computing device to:
perform a method of reducing power consumption in a communications device, the method comprising:
splitting a received audio-video (AV) signal into an encoded audio signal and an encoded video signal;
processing the encoded video signal, by video processing circuitry, to generate a resulting processed encoded video signal;
responsive to receiving a pass-block instruction that indicates that only audio content of the AV signal is desired, blocking the encoded video signal from being processed by blocking the encoded video signal from being processed by the video processing circuitry; and
reducing power consumption by the video processing circuitry responsive to receiving the pass-block instruction that indicates that only video content of the AV signal is desired.

24. A computer readable storage device having a non-transitory computer program stored thereon, execution of which by a computing device causes the computing device to:
perform a method of reducing power consumption in a communications device, the device configured to receive and present audio-video (AV) content, the method comprising:
transmitting a request to a provider of the AV content to provide a requested encoded signal that comprises an encoded audio signal only, the encoded audio signal representing audio content of the AV content;
receiving the requested encoded signal;
decoding and processing the received requested signal and presenting the decoded and processed signal to a user; and
placing video processing circuitry of the communications device into a low-power-consuming state when the requested encoded signal is an audio signal only.
